(19) United States
(12) Patent Application Publication
(10) Pub. No.: US 2004/0118943 A1
(43) Pub. Date: Jun. 24, 2004

(54) Liquid atomizing cabinet

(76) Inventor: Jr-Hung Huang, Taipei (TW)

Correspondence Address: Jr-Hung Huang, Po Box 82-144, Taipei, TW

(21) Appl. No.: 10/326,986

(22) Filed: Dec. 24, 2002

(51) Int. Cl. A62C 13/62

(52) U.S. Cl. 239/303

(57) ABSTRACT

A liquid atomizing cabinet comprised of a cabinet, containing a hollow space in its upper part and a cell tray in its lower, a through hole being provided at the front face of the hollow space; an atomizing energy converter being disposed in the front of the cabinet to guard both sides of the through hole; and a box to place fragrant, mosquito liquid, an outlet made of fiber material with excellent water absorption being provided at the front of the box to merely hold against the energy converter when the box being placed in the hollow space; the liquid being soaked through the energy converter and driven by an oscillation circuit to be atomized and sprayed out of the cabinet.

### BACKGROUND OF THE INVENTION

(a) Field of the Invention

The present invention is related to a liquid atomizing cabinet, and more particularly, to one that is common to various types of liquids for achieving the optimal atomizing effects by ultra-sonic oscillation.

(b) Description of the Prior Art

Liquid fragrant or mosquito-liquid generally available in the market is usually diffused either by electric heating or being contained in a pressurized cylinder. Since it takes to heat the ceramic up to a certain temperature before the chemical solvent to evaporate, patience is required; besides, the diffusion is prevented at where no socket is available. As for the pressurized cylinder, it requires using pressurized gas to fill up the liquid, meaning the presence of a certain hazard; and the liquid sprayed from the cylinder is not atomized so to limit the range of diffusion.

Furthermore, the existing fragrant and mosquito-liquid are different products from each other. As a result, the consumer has to purchase a lot of such products and that could be a problem of storage.

### SUMMARY OF THE INVENTION

The present invention is related to a liquid atomizing cabinet, and more particularly, to one that is common to various types of liquids for achieving the optimal atomizing effects by ultra-sonic oscillation.

The primary purpose of the present invention is to provide a liquid atomzing cabinet that can be alternatively used for different types of liquid and achieve the optimal atomizing effects by means of ultra-sonic oscillation to promote the value of the product.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a preferred embodiment of the present invention.

FIG. 2 is an exploded view of the preferred embodiment of the present invention.

FIG. 3 is an exploded view of an energy converter of the preferred embodiment of the present invention.

FIG. 4 is a sectional view of the preferred embodiment of the present invention.

FIG. 5 is a circuit drawing of the preferred embodiment of the present invention.

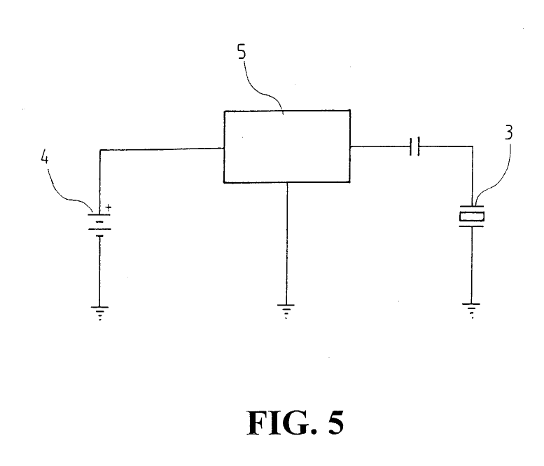

FIG. 6 is a schematic view showing the preferred embodiment of the present in use.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

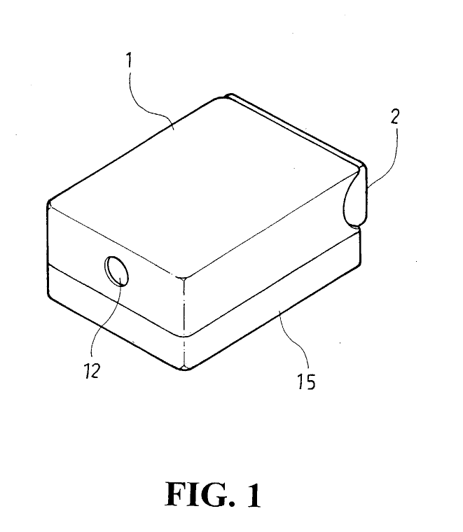

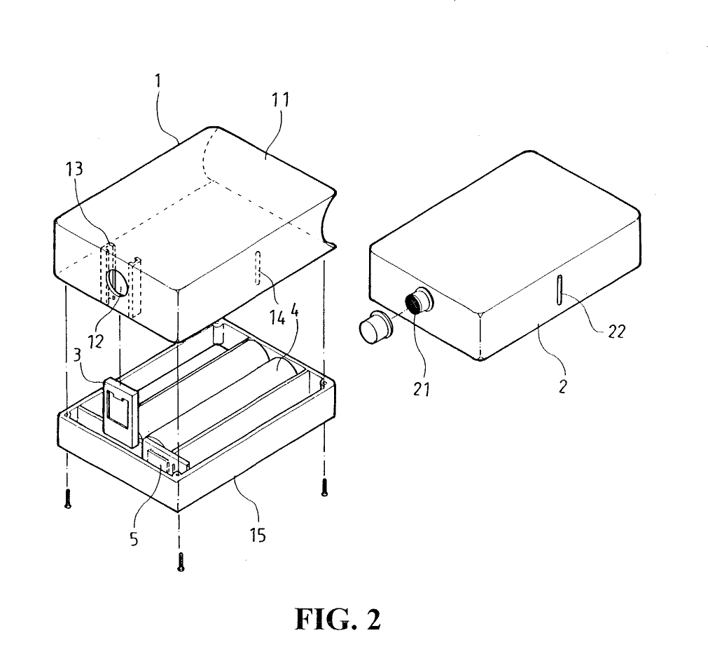

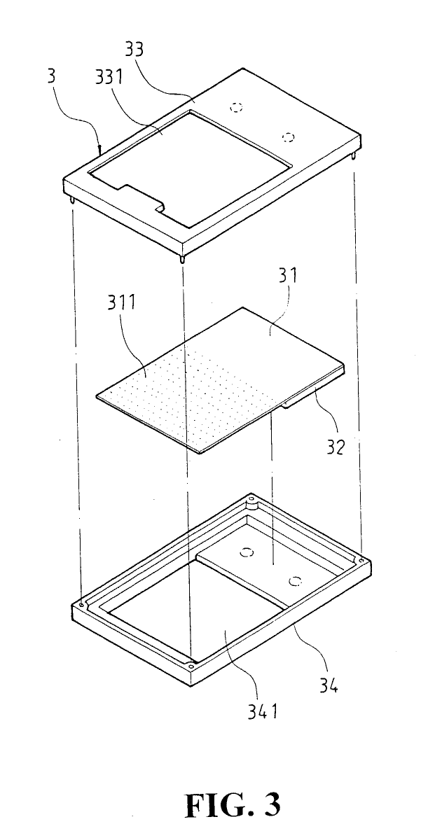

Referring to FIGS. 1, 2, and 3, a preferred embodiment of a liquid atomizing cabinet of the present invention is essentially comprised of a cabinet 1 and multiple boxes 2. Wherein, a hollow space 11 is provided in the upper part inside the cabinet 1, and a through hole 12 is provided at the front edge of the hollow space 1. A channel 13 is each disposed on the front of the cabinet at where guarding both sides of the through hole 12 to receive insertion of an atomizing energy converter 3. A vertical groove 14 is each provided at where appropriately on the longer sides of the cabinet 1. A cell tray 15 is provided in the lower part of the cabinet to accommodate multiple cells 4 and a drive circuit 5.

Each of said boxes 2 is provided to fill up liquid fragrant or mosquito-liquid. An outlet made of fibrous material with excellent water absorption is provided at the front of the box 2 and a rib 22 to match the vertical groove 14 from the hollow space 11 of the cabinet 1 is each provided on both sides of the box 2.

The atomizing energy converter 3 includes a metal foil 31 adapted with multiple minute nozzles 311. The metal foil 31 is adhered to a piezoelectric sheet ceramic 32 and then fixed to where between an upper lid 33 and a lower lid 34 respectively provided with a framed opening 331,341. The sheet ceramic 32 is connected to the drive circuit 5.

The box 2 is placed in the hollow space 11 of the cabinet 1 and held in position by clicking the rib 22 into the groove 14 for the outlet 21 of the box 2 to hold against the metal foil 31 of the atomizing energy converter 31. The metal foil 31 is oscillated at 168 KHz from the drive circuit 5 to atomize and spray out the liquid contained in the box 2. Each of those multiple boxes 2 may contain different liquid and the user may depending on the occasion select the suitable box 2 to diffuse liquid fragrant or mosquito-liquid for multiple applications.

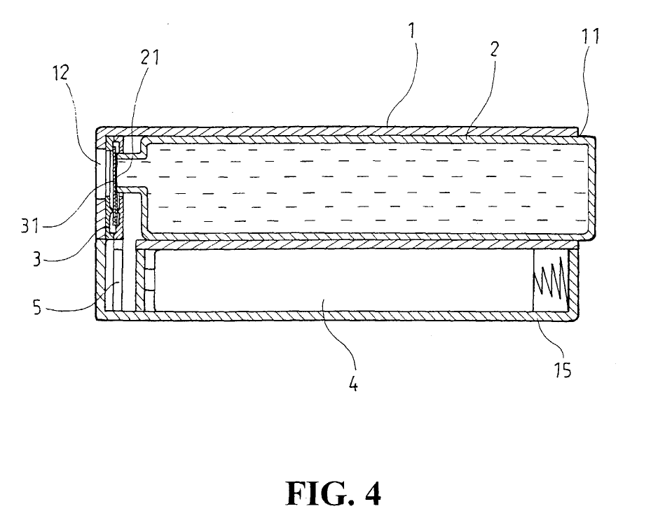

As illustrated in FIG. 4, the box 2 is placed in the hollow space 11 of the cabinet 1 with its outlet 21 merely holding against the metal foil 31 of the atomizing energy converter 3. Liquid soaks through the fibrous material in the outlet and reaches the metal foil. The liquid is then oscillated at 168 KHz by the drive circuit 5 to be sprayed out of the through hole 12 on the cabinet 1.

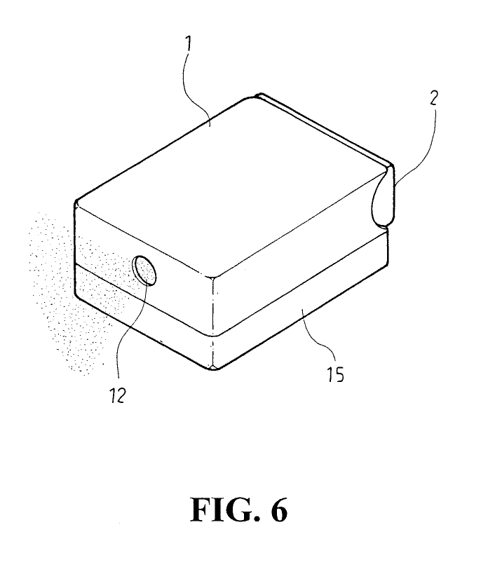

Now referring to FIG. 6, multiple cells are used as the power source making the present invention compact for use in any occasion and any location; and the grains atomized are in identical diameter to enlarge the range of diffusion to serve multiple purpose in one and thus to promote its commercial value.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A liquid atomizing cabinet is essentially comprised of a cabinet and multiple boxes; the cabinet containing a hollow space in its upper part; a through hole being provided on the front of the cabinet, a channel being each disposed on the front of the cabinet at where guarding both sides of the through hole to receive insertion of an atomizing energy converter, a cell tray being provided in the lower part of the cabinet to accommodate multiple cells and a drive circuit; the box containing liquid fragrant, mosquito-liquid or other type of liquid having an outlet made of fibrous material with excellent water absorption disposed at its front; the box being placed in the hollow space with its outlet holding against the atomizing energy converter; the liquid soaking through the outlet to reach the atomizing energy converter; and the liquid being atomized by oscillation from the drive circuit.

2. A liquid atomizing cabinet as claimed in claim 1, wherein, a vertical groove is each provided at where appropriately on the longer sides of the cabinet and a rib to match the vertical groove from the hollow space of the cabinet is each provided on both sides of the box to hold the box in position by clicking the rib into its respective groove.
